(19) United States
(12) Patent Application Publication
(10) Pub. No.: US 2009/0100339 A1
(43) Pub. Date: Apr. 16, 2009

(54) Content Acess Tree

(76) Inventors: Hassan Hamid Wharton-Ali, Pacific Palisades, CA (US); Anand Kapoor, Paramount, CA (US)

Correspondence Address: Robert D. Shedd;Thomson Licensing LLC, PO Box 5312, PRINCETON, NJ, 08543-5312, US

(21) Appl. No.: 12/224,728

(22) PCT Filed: Dec. 1, 2006
(86) PCT No.: PCT/US06/46210

§ 371 Date: Sep. 4, 2008

Related U.S. Application Data
(60) Provisional application No. 60/780,818, filed on Mar. 9, 2006.

(51) Int. Cl. G06F 3/048

(52) U.S. Cl. 715/720; 715/855; 715/838

(57) ABSTRACT

A system and method are disclosed for visualizing, manipulating and encoding video stream data via a hierarchical format in a graphical user interface where at least one segment reduced image represents a sequential portion of a video stream, each segment having at least one scene, at least one scene reduced image representing a scene in each segment, each scene having at least one frame, and displaying at least one frame reduced image, each frame reduced image representing a frame in the scene. The system and method further include displaying buttons allowing a user to encode at least a portion of the video stream. In this system, at least one segment is an active segment, and the scenes displayed are part of the active segment. Additionally, one scene is an active scene, and the frames displayed are part of the active scene.

### CROSS REFERENCE TO RELATED APPLICATIONS

This application claims the benefit of U.S. Provisional Application Ser. No. 60/780,818, filed Mar. 9, 2006, which is incorporated by reference herein in its entirety.

### TECHNICAL FIELD

The present principles generally relate to image display systems and methods, and, more particularly, to a system and method for categorizing and displaying images and properties of segments, scenes and individual frames of a video stream.

### BACKGROUND

Recently, consumer video products have moved from analog cassette tapes to digital format. Video in the form of Digital Video Disc (DVD) is currently the most popular format. New, higher density video formats, such as Blu-Ray™ and High Definition Digital Video Disc (HD-DVD) have also been recently introduced.

Digital video data put into a format for consumer use is generally digitally compressed and encoded prior to sale. Frequently, the encoding includes some form of compression. In the case of DVDs, the video is encoded using the MPEG-2 standard. Additionally, the Blu-Ray™ and HD-DVD formats also store data on the disc in an encoded form. However, because of the complexity of the compression system, and the desire to achieve the highest compression while retaining the highest video quality, the encoding must be done largely one frame, or one scene, at a time. Frequently, Blu-Ray™ and HD-DVD compression of a feature length theatrical release may take upwards of 8 hours to encode.

After a video scene is encoded, the resulting encoded video must be verified for accuracy. It is common for scenes having large numbers of moving objects to require a lower encoding rate to ensure that the encoded frames are each displayed in the final product correctly. Therefore, a software program for viewing and encoding video is commonly used.

Traditionally, most user interfaces involved in image production work include two main features, a timeline and a preview window. Generally, a user is able to view only one frame from a video content stream, while using the timeline to randomly access a single different frame, by moving a timeline cursor along the timeline's axis until the desired frame appears in the preview window. Although this provides the user with random access to the video stream content, it requires users to pay attention to both the timeline and the preview window. Additionally, users must search for particular frames or scenes by scrolling through the timeline. Such access is inefficient and can be time consuming.

U.S. Pat. No. 6,552,721, to Ishikawa, issued on Apr. 22, 2003, describes a system for switching file scopes comprised of sets of nodes referred to by a file being edited. Additionally, a scene graph editing tool allows users to display a hierarchical tree format for nodes referring to VRML content being edited.

U.S. Pat. No. 6,774,908, to Bates, et al., issued on Aug. 10, 2004, discloses an image processing system for allowing a user to designate portions of a video frame to be tracked through successive frames so that the quality of playback, lighting and decompression may be compensated for.

U.S. Patent Application No. 20060020962, filed Jan. 26, 2006, to Stark et al., discloses a graphical user interface for presenting information associated with various forms of multimedia content.

U.S. Patent Application No. 1999052050, filed Oct. 14, 1999, to French, et al., discloses representing a visual scene using a graph specifying temporal and spatial values for associated visual elements. The French, et al., application further discloses temporal transformation of visual scene data by scaling and clipping temporal event times.

None of the prior art provides any system or method for efficiently and randomly accessing known portions of a video stream. What is needed is a user friendly interface that can show video content data in a hierarchical manner. Additionally, such user interface should permit a user to group, either automatically or manually, scenes, frames and the like, into logical groups that may be accessed and analyzed based on properties of the visual data encompassed by such scene or frame. Due to the time needed for processing a complete feature length video, an ideal system would also allow a user to selectively manipulate any portion of the video, and show the storyline for efficient navigation.

### SUMMARY

The present principles are directed to displaying portions of video content in a hierarchical fashion.

According to an aspect of the invention, there is provided a method for representing a portion of a video stream with at least one segment having at least one scene and the scene having at least one frame, and formatting the at least one segment, scene and frame so that at least one segment of the video stream is designated as an active segment and the scenes for display are part of the active segment.

According to another aspect of the invention, there is provided a user interface, manipulating and encoding video stream data via a hierarchical format. The hierarchical format includes at least one class thumbnail image representing a plurality of scenes from of a video stream, each class thumbnail image having at least one associated information bar at least one scene thumbnail image representing a scene in a class, each scene having at least one frame, each scene thumbnail image having at least one associated information bar, at least one frame thumbnail image, each frame thumbnail image representing a frame in a scene, each frame thumbnail image having at least one associated information bar. Furthermore, this aspect may include each information bar displaying the frame number, frame time and class information of the associated thumbnail image.

According to yet another aspect of the invention, there is provided a method for displaying video stream data via a hierarchical format in a graphical user interface, the method comprising displaying at least one scene thumbnail image representing a scene, each scene having at least one frame, displaying at least one frame thumbnail image, each frame thumbnail image representing a frame in the scene, and displaying at least one category, each category having at least one scene. This aspect may further comprise displaying at least one segment thumbnail image representing a segment of a sequential digital image, each segment having at least one scene, wherein each scene displayed is part of a segment. In such aspect, the method optionally includes loading video stream data, determining the beginning and ending of each segment automatically and determining the beginning and ending of each scene automatically. This aspect may further comprise displaying at least one button for allowing a user to encode at least a portion of the video stream.

### BRIEF DESCRIPTION OF THE DRAWINGS

The advantages, nature, and various additional features of the present principles will appear more fully upon consideration of the illustrative embodiments now to be described in detail in connection with accompanying drawings wherein:

FIG. 1 is a block diagram of an illustrative embodiment of a element hierarchy of a content access tree in accordance with an embodiment in accordance with the present principles;

FIG. 2 is flow diagram of an exemplary system for displaying video content via a content access tree in accordance with one embodiment in accordance with the present principles;

FIG. 3 is a block diagram of an illustrative embodiment of an arrangement for display and manipulation of data of a content access tree in accordance with the present principles.

FIG. 4 is a block diagram showing a detailed illustrative embodiment of a single content access tree element in accordance with the present principles.

FIG. 5 is a diagram showing a detailed illustrative embodiment of a user interface embodying the present principles.

FIG. 6 is a block diagram showing an alternative detailed illustrative embodiment of an arrangement for display and manipulation of data of a content access tree in accordance with the present principles.

It should be understood that the drawings are for purposes of illustrating the concepts of the present principles and are not necessarily the only possible configuration for illustrating the present principles.

### DETAILED DESCRIPTION OF THE INVENTION

The present principles provide a system and method for displaying images from a video stream in a hierarchically accessible tree, and allowing the encoding and subsequent assessment and manipulation of the video quality.

It is to be understood that the present principles are described in terms of a video display system; however, the present principles are much broader and may include any digital multimedia system, which is capable of display or user interaction. In addition, the present principles are applicable to any video display or editing method including manipulation of data displayed by computer, telephone, set top boxes, computer, satellite links, etc. The present principles are described in terms of a personal computer; however, the concepts of the present principles may be extended to other interactive electronic display devices.

It should be understood that the elements shown in the FIGs. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative modules embodying the principles of the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage. Additionally, when provided on a display, the display may be on any type of hardware for rendering visual information, which may include, without limitation, CRT, LCD, plasma or LED displays, organic or otherwise, and any other display device known or as yet undiscovered.

The functions of the encoding or compression described herein may take any form of digitally compatible encoding or compression. This may include, but is not limited to, any MPEG video or audio encoding, any lossless or lossy compression or encoding, or any other proprietary or open standards encoding or compression. It should be further understood that the terms encoding and compression may be used interchangeably, both terms referring to the preparation of a data stream for reading by any kind of digital software, hardware, or combination of software and hardware.

Other hardware, conventional and/or custom, may also be included. Similarly, any switches, buttons or decision blocks shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

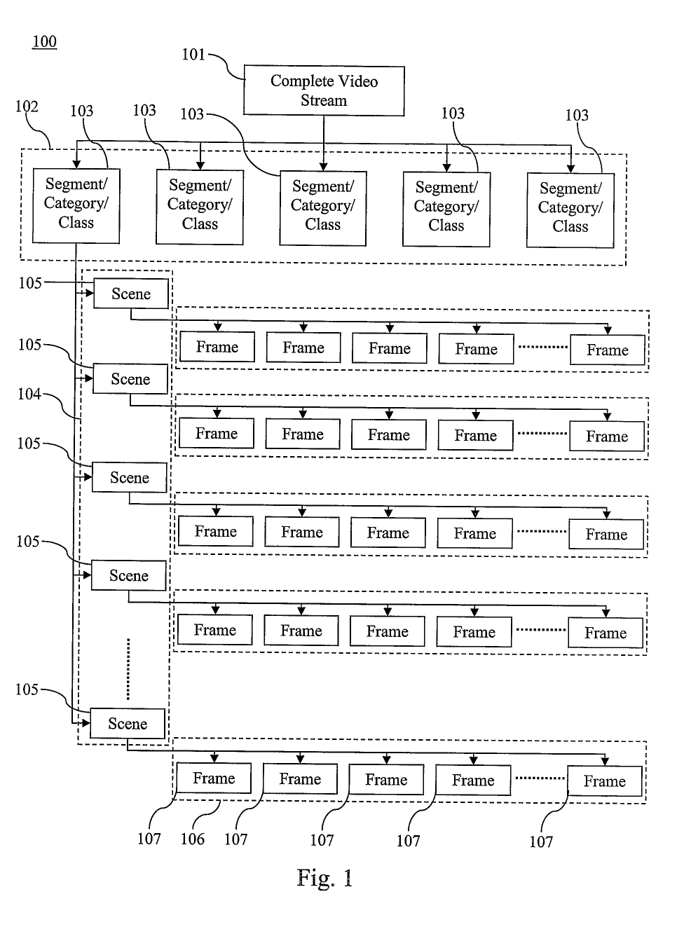

Referring now in specific detail to the drawings in which like reference numerals identify similar or identical elements throughout the several views, and initially to FIG. 1, a block diagram of an illustrative embodiment of an element hierarchy 100 of a content access tree in accordance with an embodiment of the present principles is depicted. Initially, a least one complete video stream 101 is operated on. The complete video stream may be comprised of multiple files and may also be part of a larger video stream.

At the outset, it should be noted that a complete video stream 101 is comprised of a group of segments 102, where each segment 103 is in turn comprised of a group of scenes 104, and where each scene 105 is in turn comprised of a group of frames 106.

The complete video stream 101 is comprised of a group of segments 102, the group 102 having a plurality of segments 103, with the totality of the segments 103 encompassing the entirety of the original complete video stream 101.

A segment 103 may be a linear representation of a portion of the complete video stream 101. For example, each segment may, by default, represent five minutes of a video stream, or may represent at least five minutes of the complete video stream 101, but be terminated at the first scene end after the five minute mark. The user may decide on default segments lengths, and the user may also edit the automatically generated segment periods. Furthermore, a segment may represent a fixed number of scenes, or any other rational grouping.

For example, in one useful embodiment, each segment may be a non-linear category of scenes 105 categorized based on similar video properties. In yet another useful embodiment, each segment 103 may be a class comprised of a group of scenes 104 logically classified by any other criteria.

Each segment 103 is comprised of a group of scenes 104, where the group of scenes 104 is comprised of a plurality of individual scenes 105. In one useful embodiment, the scene may represent a continuous, linear portion of the complete video stream 101.

Likewise, each scene 105 is comprised of a group of frames 106, the group 106 being comprised of a plurality of individual frames 107. In one particularly useful embodiment, each frame 107 is a standard video frame.

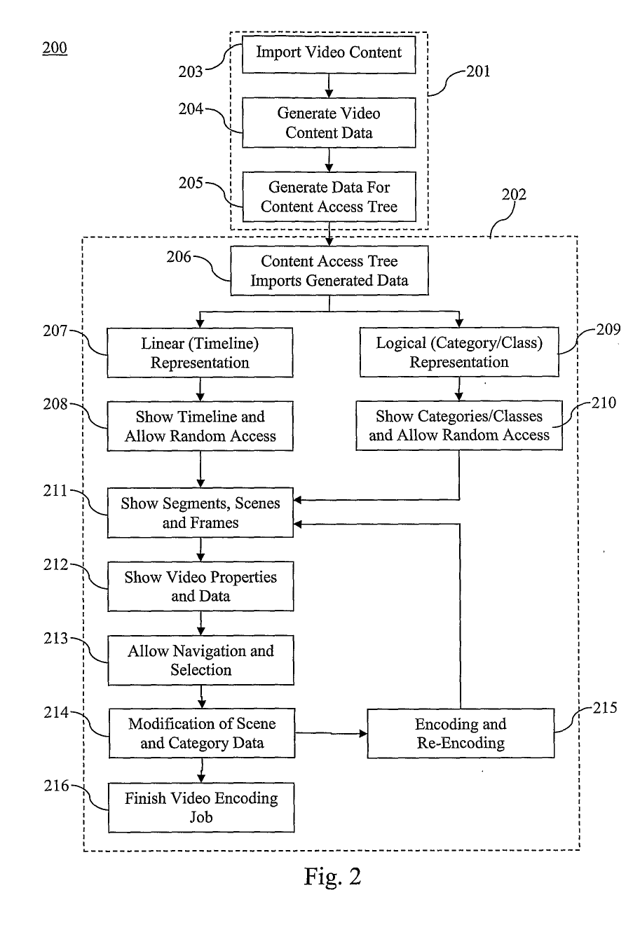

Referring now to FIG. 2, a flow diagram of an illustrative embodiment of a system for generating and displaying content of a video stream in a hierarchical format 200 is depicted. This system 200 may have a non-interactive portion in block 201, and an interactive portion in block 202.

Details of the individual block components making up the system architecture are known to skilled artisans, and will only be described in details sufficient for an understanding of the present principles.

In the non-interactive portion in block 201 of the system, the system may import the video content in block 203, generate video content data in block 204, and generate data for the content access tree in block 205. The non-interactive portion of the system in block 201 may be performed in an automated fashion, or may already exist, created by, for example, previous operations of the system 200, or by other, auxiliary or stand alone, systems.

When importing the video content in block 203, the video content may be loaded into a storage media, for example, but not limited, to Random Access Memory (RAM), any kind of computer accessible storage media, computer network, or real-time feed. The system 200 may then generate video content data in block 204. This generation step in block 204 may include detecting scenes, generating histograms, classification of scenes and frames based on color, similarity of scenes, bit rate, frame classification, and generation of thumbnails. Currently, software and algorithms for automatically detecting the transitions between scenes is frequently used, and is well known to those skilled in the art.

The system may further generate data in block 205 usable for displaying the content access tree. This data may include, but is not limited to, for example, generating indexes, markers or other data needed to manage the relationship of data elements, for defaulting the display options when displaying the video content, or for annotating any of the video data. Any data generated in blocks 204 and 205 may also be saved for future use or reuse, and such saving may occur at any time during the generation process. Such saving features are readily apparent to those skilled in the art, and therefore may be implemented in any fashion known, or as yet undiscovered.

The interactive portion, block 202, of the system 200 may then operate on the data previously prepared by the non-interactive portion in block 201. The content access tree system 200 may import, in block 206, the data generated by the non-interactive portion in block 201 of the system 200. The data displayed may take the form of a linear, or timeline, representation, in block 207, and may also include a logical category and/or class display in block 209. In one useful embodiment, both a timeline representation and a logical representation are displayed so that a user may manually categorize scenes selected from the timeline.

When a timeline representation in block 208 generated, a timeline is displayed from which random access to segments, scenes, and frames is allowed in block 209. The video segments, scenes and frames are displayed to the user in block 211 as display elements.

When a logical (classification) representation in block 209 is generated. The representations of categories or classes are displayed, and random access permitted in block 210. The representations may be altered or defined by the user, or may alternatively be automatically generated.

For example, a user may be presented with a user interface with classes or scenes automatically categorized, where the user interface permits manual changes to the automated classification of the classes or scenes.

In the case of both a linear (timeline) representation in block 207, and a logical (classification) representation in block 209, the segments, scenes and frames are then shown in block 211. In one useful embodiment, a segment may be made active, with the scenes displayed being from the active segment, and a scene may be made active so that the frames displayed will depend on the active scene.

Additionally, video data may be displayed in block 212. In particularly useful embodiments, this video data may be category or classification properties for each scene and segment. In another particularly useful embodiment, data relating to each frame may be displayed. In one embodiment, this may take the form of color data, frame bit rate data, or any other useful data.

The user is then allowed to navigate and select data within the display in block 213. In one useful embodiment, a user may be allowed to select the active segment, with the scenes and frames displayed changing to reflect the contents of the active segment. Likewise in this useful embodiment, the user may change the active scene through selection, for example, by clicking the mouse on the desired scene, and causing the frames comprising the newly selected active scene to be displayed.

In block 214, the user may modify the data related to each segment, scene, frame or category. In one useful embodiment, each category may have default parameters associated with it, for example, but not limited to color information, encoding bit rate, and the like. In one such useful embodiment, the default parameters may be such that when a scene is added to a category, the default parameters are applied to the newly added scene. The user may also, in block 214, aggregate scenes into categories. In one useful embodiment, the categories, which are comprised of a plurality of scenes, may treated similarly during the encoding process. In another useful embodiment, the user may also change the scene markers, that is, to indicate which frames belong to a scene, overriding the automated scene detection process.

After the user has had the opportunity to navigate the available video data in block 213, and make any modifications in block 214, the user may encode or re-encode, in block 215, any or all of the segments, scenes, or categories. The encoding or re-encoding process may take place on a remote computer, or may take place on the user's computer terminal. In one useful embodiment, segments, scenes, or categories are queued for encoding. The user may then view and verify other portions of the video data while the specified parts are being encoded or re-encoded. The encoding of scenes may be assigned a priority, allowing the encoding to proceed in a nonlinear fashion. After the encoding and re-encoding in block 215, the newly encoded segment, scenes or categories are then displayed again. In one useful embodiment, the user may then verify that the encoding or re-encoding in block 215 took place properly, with the encoded video portions displaying properly. After the user is satisfied that all of the video scenes have been properly encoded, and the user needs to perform no more modification of the data in block 214, the video encoding job is completed in block 216. In one useful embodiment, the video may then be placed on a master disc for duplication and subsequent sale of reproduced media.

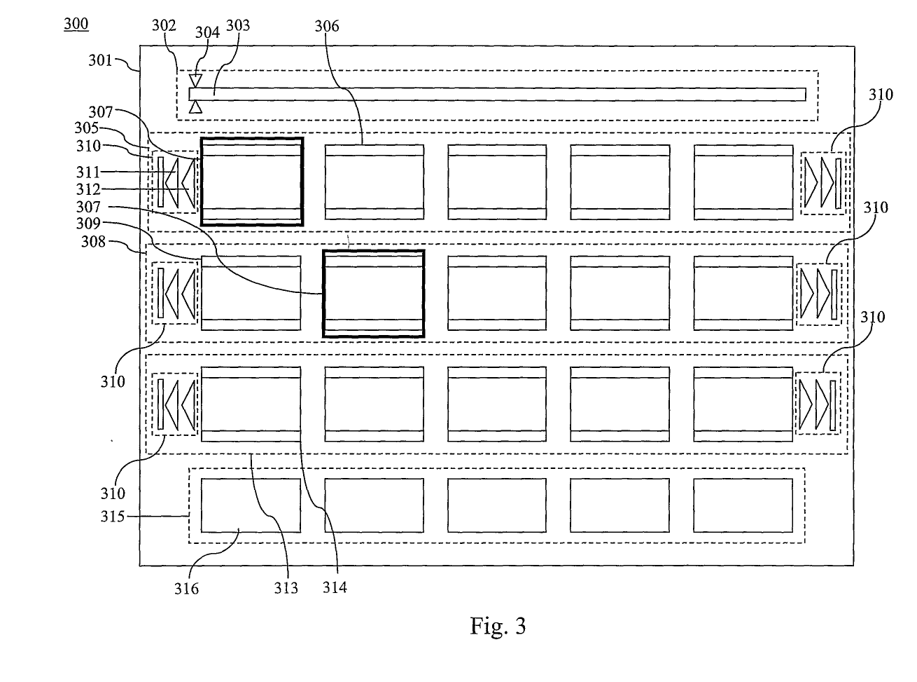

Referring now to FIG. 3, a diagram of an illustrative embodiment of an interface for displaying content of a video stream in a hierarchical format 300 is depicted. Details of the individual components making up the system architecture are known to skilled artisans, and will only be described in details sufficient for an understanding of the present principles. Optional interface elements such as menus, buttons, and other like interactive items are known to the skilled artisan to be interchangeable, and are not meant as a limitation upon the present principles.

The elements of the interface 300 are displayed within a viewable display area 301 or display. In one particularly useful embodiment, the display 301 may be, but is not limited to, a computer monitor connected to a personal computer, a laptop screen, or the like. The display may include a timeline 302 representing the time sequence of the complete video stream and the point in time the segment, scene and frames displayed represent. The timeline may include a timeline indicator 304 which represents the position of the currently active segments or classes and scenes. The timeline indicator 304 may be manually moved to access the segments and scenes corresponding to the time to which the timeline indicator 304 is moved. The timeline 302 may further include a timeline bar 303 which represents the totality of the length of the video stream content.

A particularly useful embodiment may include the display showing a group of segment display elements 305 comprised of a plurality of segment display elements 306. The segment display elements 306 may display a thumbnail or other visual information representative of the segment. Additionally, one of the segment display elements 306 may have one or more additional visual elements 307 to indicate that the segment represented by the segment display element 306 is the active segment of which the scenes 309 are a part. In one useful embodiment, additional visual element 307 indicating the active segment may be a block, outline, or colored background around the active segment. In yet another useful embodiment, the additional visual element 307 may be used to indicate the active scene or frame.

The group of segments may also have one or more groups of navigation buttons 310 associated with this group. Each group of navigation buttons 310 may be comprised of a single movement button 312, and a jump button 311. The single movement button 312 may scroll the scenes displayed as part of the scene group 308 right or left, permitting a user to access scenes that are part of the active segment or class, but that are not displayed. Additionally, the jump button 311 may permit a user to advance directly to the scene at the beginning or end of a segment. In a particularly useful embodiment, these buttons may be useful when the number of scenes in the segment or class exceed the space available to show scenes. Additionally, a group of such navigation buttons may be associated with the scenes and frames, and may be used to scroll the scenes and frames as well.

A particularly useful embodiment may also include the display showing a group of scene display elements 308 comprised of a plurality of scene display elements 309. The scenes displayed are scenes from the segment or class currently active and may be represented by additional visual elements 307. The scene display elements 309 may display a thumbnail or other visual information representative of the scene. Additionally, one of scene display elements 309 may have one or more additional visual elements 307 to indicate that the scene represented by the scene display element 309 is the active scene of which the frames 314 displayed are a part.

In another particularly useful embodiment, the display may also show a group of frames 313 having a plurality of frame display elements 314, each element showing a different frame. The frames shown in the frame display elements 314 are frames from the active scene, and by descendancy, also from the active segment or class.

Another particularly useful embodiment may include a group of histograms 315 having a plurality of histograms 316. Each histogram may correspond to an individual frame display element 314, and may show information related to the frame shown in the frame display element 314. For example, the histogram may show information related to bit rate, frame color information or the like.

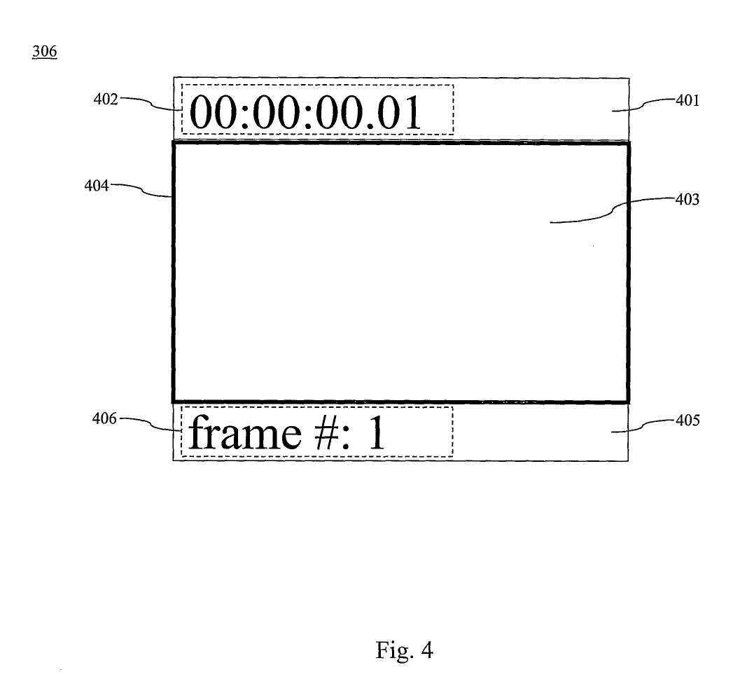

Referring now to FIG. 4, a detailed diagram of an illustrative embodiment of an interface display element 306 is depicted. An interface display element may be used to display a thumbnail representation of a segment, class, scene, or a thumbnail of an individual frame. The thumbnail may be shown in the thumbnail display area 403. The interface display element 306 may also have an upper information bar 401 and a lower information bar 405. In a particularly useful embodiment, the upper information bar 401 may show information 402 such as the time within the video content stream that the displayed thumbnail represents. Likewise, a particularly useful embodiment may have the lower information bar 405 show information such as the frame number of the thumbnail shown in the interface display element 306. Additionally, the upper and lower information bars 401, 405 may be used to convey information relating to the class or other like information. For instance, the information bars 401, 405 may be colored to indicate a classification based on properties related to the segment, class, scene, or frame.

The interface display element 306 may additionally have an area for showing additional interface visual elements 404. This additional visual element may optionally be included to indicate which segment or class is currently active.

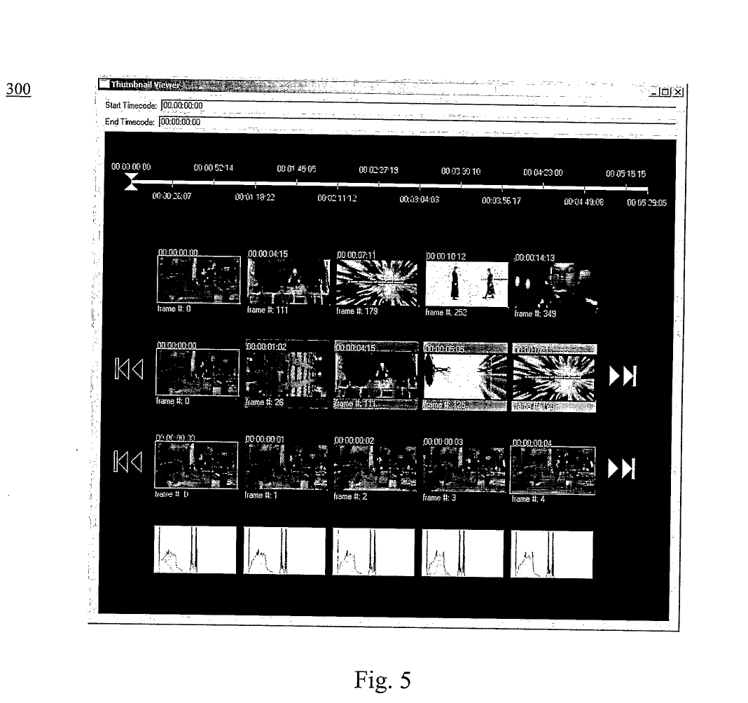

Referring now to FIG. 5, a diagram of one illustrative embodiment of a user interface 300 is depicted. In such a user interface, a user may be able to navigate the segments, scenes and frames by moving the timeline cursor. Alternatively, a user may simply click on a segment to make that scene active, and change the displayed scenes and frames, the scenes and frames displayed being part of the selected segment. Likewise, a user may simply click a scene to select the scene as the active scene, changing the displayed frames, where the frames are part of the active scene.

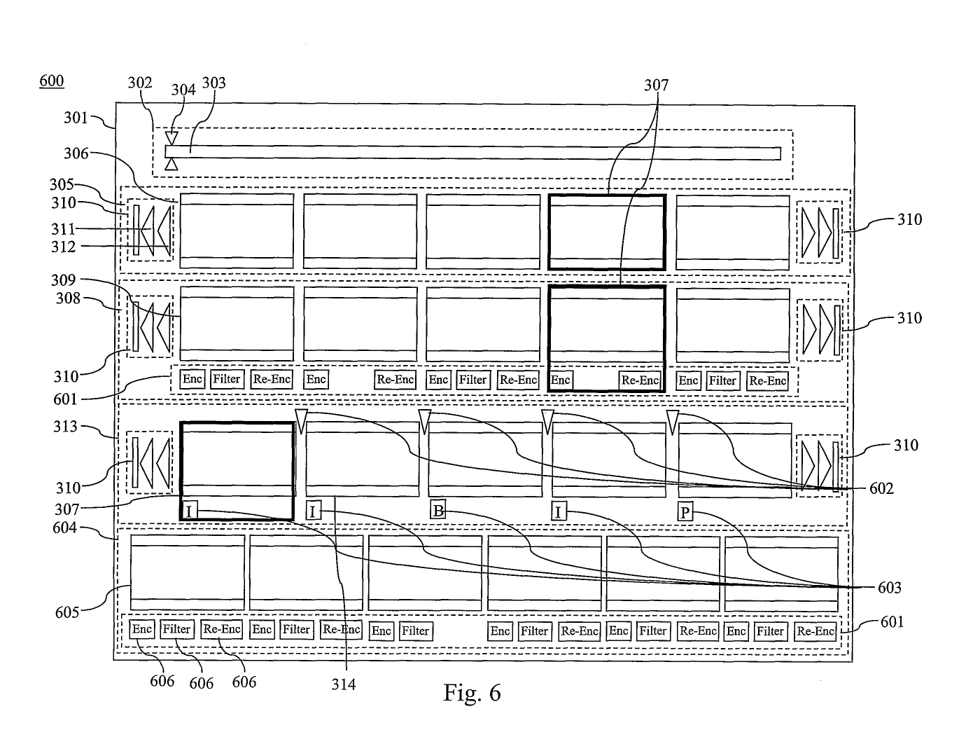

Referring now to FIG. 6, a detailed diagram of an alternative illustrative embodiment of an arrangement for display and manipulation of data of a content access tree in accordance with the present principles is depicted. In this embodiment, the interface 300 of FIG. 3 may include additional action or display elements.

A group of categories 604 may be displayed, the group of categories 604 having a plurality of categories 605. Each category may be represented by additional visual elements, and the scenes 314 belonging to each category 605 may display the additional visual elements for convenient user perusal. In one useful embodiment, a user may be able to categorize scenes 309 by dragging and dropping the scene display element 309 onto the relevant category display element 605. In an alternative embodiment, the user may use a mouse to click the scene display element 309 and select the category 605 from a drop down menu.

The interface 300 may also have one or more groups of action buttons 601, comprised of a plurality of action buttons 606. One or more action buttons 606 may be associated with each scene or category. The action buttons 606 may allow a user to queue a scene or category for initial encoding, re-encoding, or filtering. In a particularly useful embodiment, scenes or categories that have not been initially encoded will have an action button 606 for encoding scenes or categories associated with the button 606. In another useful embodiment, an action button may also allow a user to filter a scene or category. Additionally, a user may right click on any thumbnail or information bar to allow the user to take action on or view information on the selected thumbnail or information bar.

The interface 300 may also have scene markers 602 displayed as well. In one useful embodiment, the scene markers 602 are disposed in a way as to allow a user to visually discern the boundaries of a scene, e.g. the grouping of frames in a scene. In another useful embodiment, the user may mouse click a scene marker 602 to create or remove a scene boundary. In this embodiment, the user may select the scene marker 602 to correct the automatic scene detection performed when the original video data was imported.

Frame information markers 603 may also be displayed in the interface, and be associated with a frame 314. The frame information marker 603 may be part of frame display element 314, or may be displayed in any other logical relation to the frame 314. In one particularly useful embodiment, the frame encoding type may be displayed as text. For example, the frame information marker may indicate that a frame is compressed as a whole, that a frame is interpolated from two other frames, or that a frame is compressed as a progression of another frame.

Having described preferred embodiments for system and method for displaying video content in a hierarchical manner (which are intended to be illustrative and not limiting), it is noted that modifications and variations can be made by persons skilled in the art in light of the above teachings. It is therefore to be understood that changes may be made in the particular embodiments of the present principles disclosed which are within the scope and spirit of the present principles as outlined by the appended claims. Having thus described the present principles with the details and particularity required by the patent laws, what is claimed and desired protected by Letters Patent is set forth in the appended claims.

1. A system for processing video stream data via a hierarchical format in a graphical user interface, the hierarchical format comprising
at least one segment reduced image representing a sequential portion of a video stream, each segment having at least one scene;
at least one scene reduced image representing a scene in each segment, each scene having at least one frame;
at least one frame reduced image representing a frame in the scene; and
an interactive user interface displaying at least one segment reduced image, at least one scene reduced image, and at least one frame reduced image, wherein at least one segment is designated as an active segment, such that the scenes displayed are part of the active segment, and wherein one scene is designated as an active scene, and the frames displayed are part of the active scene.

2. The system of claim 1, wherein the at least one segment reduced image is selectable to select the active segment and where selection of a segment reduced image permits a user to view the at least one scene of the active segment.

3. The system of claim 2, wherein the system further comprises a visual element indicating the active segment.

4. The system of claim 1, wherein the at least one scene reduced image is user selectable to select the active scene and to permit a user to view the at least one frame of the active scene.

5. The system of claim 4, wherein the system further comprises a visual element indicating the active scene.

6. The system of claim 1, further comprising at least one histogram, each histogram being associated with each displayed frame reduced image, each histogram representing at least one property of the associated frame.

7. The system of claim 1, further comprising at least one button for allowing a user to encode at least one scene of the video stream.

8. The system of claim 7, wherein the reduced images display the encoded video streams, the system further comprising at least one button for re-encoding at least one scene of the video stream.

9. The system of claim 1, further comprising visual elements representing scene markers, wherein the scene markers (602) are user selectable to determine the frames comprising a scene.

10. The system of claim 1, further comprising at least one category, each category comprised of at least one scene, wherein the scenes comprising the category are user selectable.

11. The system of claim 10, wherein the at least one category may be encoded at the selection of the user, the scenes comprising a selected category being individually encoded.

12. The system of claim 1, further comprising a timeline, wherein the active segment may be selected with the timeline, wherein the active scene is selectable using the timeline.

13. A system for processing video stream data via a hierarchical format in a graphical user interface, the hierarchical format comprising:
at least one class reduced image representing a plurality of scenes from of a video stream, the at least one class reduced image including an associated information bar and being user selectable to be active;
at least one scene reduced image representing a scene in a class, each scene having at least one frame and an associated information bar and being user selectable to be active, the at least one scene reduced image comprising the active class;
at least one frame reduced image, each frame reduced image representing a frame in a scene and having an associated information bar and an associated frame information marker, the at least one frame reduced image comprising the active scene; and
at least one encoding button allowing a user to encode at least a portion of the video stream; and
an interactive user interface for displaying at least one class reduced image, at least one scene reduced image, at least one frame reduced image, and at least one encoding button, wherein a segment is designated as an active segment, such that the scenes displayed comprise the active segment, and wherein one scene is designated as an active scene, and the frames displayed comprise the active scene.

14. The system of claim 13 wherein said information bar displays the frame number and frame time of the associated reduced image.

15. The system of claim 13, wherein each information bar associated with a class displays class information regarding the associated class.

16. A method for processing video stream data via a hierarchical format in a graphical user interface, the method comprising:
displaying at least one scene reduced image representing a scene, each scene having at least one frame;
displaying at least one frame reduced image, each frame reduced image representing a frame in the scene; and
displaying at least one category, the category being comprised of at least one scene; and
displaying an interactive user interface, at least one scene reduced image, and at least one frame reduced image, wherein one scene is designated as an active scene, and the frames displayed are part of the active scene; and
displaying at least one button permitting the user to encode at least one scene.

17. The method of claim 16, the method further comprising displaying at least one segment reduced image representing a segment of a sequential digital image, the segment having at least one scene, wherein each scene displayed is part of a segment.

18. The method of claim 17, the method further comprising:
loading video stream data;
determining the beginning and ending of each segment automatically; and
determining the beginning and ending of each scene automatically.

19. The method of claim 16, further comprising:
displaying a timeline, the timeline representative of the length of at least a portion of video stream data;
permitting a user to determine the displayed at least one scene reduced image and the displayed at least one frame reduced image by selecting a time on the timeline.

20. The method of claim 16, further comprising displaying at least one button (606) for allowing the user to encode all scenes within at least one category (605).

21. The method of claim 16, further including editing the beginning and ending of each scene manually.
